(19) United States
(12) Patent Application Publication
(10) Pub. No.: US 2009/0303258 A1
(43) Pub. Date: Dec. 10, 2009

(54) INFORMATION DISPLAY APPARATUS, INFORMATION DISPLAYING METHOD, AND COMPUTER READABLE MEDIUM

(75) Inventors: Yukiyo Uehori, Tokyo (JP); Tohru Fuse, Tokyo (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Tokyo (JP)

(21) Appl. No.: 12/270,375

(22) Filed: Nov. 13, 2008

(30) Foreign Application Priority Data
Jun. 4, 2008 (JP) 2008-146943

(51) Int. Cl. G09G 5/00; G06K 9/34

(52) U.S. Cl. 345/681; 382/180

(57) ABSTRACT

An information display apparatus includes: an extracting unit that extracts a part of an image of a character sequence virtually arranged in a line, as a display area; a display unit that displays the part of the image of the character sequence within the extracted display area; a moving unit that moves the display area on the image of the character sequence; and a designating unit that designates a moving speed of the display area based on at least one of contents of an operation performed by a user and contents of the moving speed designated in past.

### CROSS-REFERENCE TO RELATED APPLICATIONS

This application is based on and claims priority under 35 U.S.C. 119 from Japanese Patent Application No. 2008-146943 filed Jun. 4, 2008.

### BACKGROUND

### Technical Field

The present invention relates to an information display apparatus, an information displaying method, and a computer readable medium.

### SUMMARY

According to an aspect of the present invention, an information display apparatus includes: an extracting unit that extracts a part of an image of a character sequence virtually arranged in a line, as a display area; a display unit that displays the character sequence image within the extracted display area; a moving unit that moves the display area on the character sequence image; and a designating unit that designates a moving speed of the display area based on at least one of contents of an operation performed by a user and contents of the moving speed designated in past.

### BRIEF DESCRIPTION OF THE DRAWINGS

Exemplary embodiment of the present invention will be described in detail based on the following figures, wherein:

FIG. 1 is a block diagram showing the configuration of an example of an information display apparatus according to an exemplary embodiment of the invention;

FIG. 2 is a functional block diagram of the information display apparatus according to then exemplary embodiment of the invention;

FIG. 3 is an explanatory diagram showing an example of a document as a subject to be processed by the information display apparatus according to then exemplary embodiment of the invention;

FIG. 4 is a flow diagram showing an example of a part of the processing performed by the information display apparatus according to then exemplary embodiment of the invention;

FIG. 5 is an explanatory diagram showing an example of a display area extracted by the information display apparatus according to then exemplary embodiment of the invention;

FIG. 6 is an explanatory diagram showing an example of the contents of moving speeds designated in the past which is recorded by the information display apparatus according to then exemplary embodiment of the invention;

FIG. 7 is an explanatory diagram showing an example of the display performed by the information display apparatus according to then exemplary embodiment of the invention;

FIGS. 8A and 8B are explanatory diagrams showing examples of the conversion of the moving speed performed by the information display apparatus according to then exemplary embodiment of the invention;

FIG. 9 is an explanatory diagram showing an example of a line-coupled image generated by the information display apparatus according to then exemplary embodiment of the invention;

FIGS. 10A to 10C are explanatory diagrams showing examples of images generated by the information display apparatus according to then exemplary embodiment of the invention;

FIG. 11 is an explanatory diagram showing an example of an image displayed by the information display apparatus according to then exemplary embodiment of the invention;

FIGS. 12A and 12B are explanatory diagrams showing other examples of images displayed by the information display apparatus according to then exemplary embodiment of the invention; and

FIGS. 13A and 13B are explanatory diagrams showing still other examples of images displayed by the information display apparatus according to then exemplary embodiment of the invention.

### DETAILED DESCRIPTION

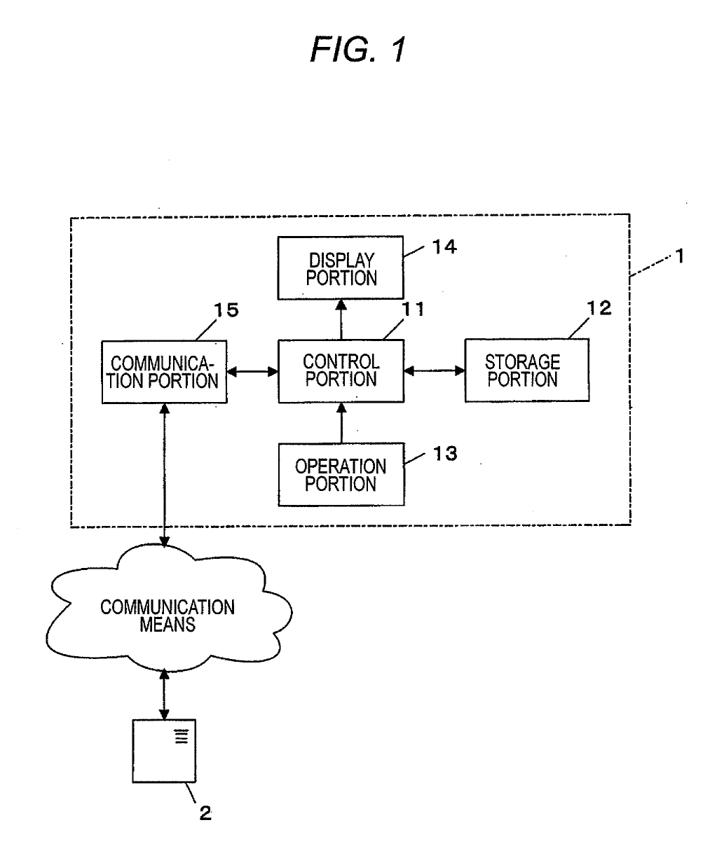

An exemplary embodiment according to the invention will be explained with reference to drawings. As shown in FIG. 1, for example, an information display apparatus 1 according to the exemplary embodiment of the invention is configured to include a control portion 11, a storage portion 12, an operation portion 13, a display portion 14 and a communication portion 15. The information display apparatus is coupled to an external server 2 etc. via a communication means such as a network so as to be able to communicate with the server etc. The information display apparatus 1 may include a communication portion for transmitting/receiving character sequence information etc. via the communication means such as the network. Further, the information display apparatus 1 may include an interface for receiving a portable-type memory device etc. to thereby transfer character sequence information etc. stored in the portable-type memory device to the storage portion 12.

The control portion 11 is a program control device such as a CPU (central processing unit) and operates in accordance with a program stored in the storage portion 12. The control portion 11 acquires character sequence information to be subjected to a display processing and generates an image of a single line formed by coupling the end portion of the n-th line with the head portion of the (n+1)-th line of the character sequence information. The control portion extracts a part of the image of one line thus generated as a display area and displays the extracted image on the display portion 14. Further, the control portion 11 moves the display area on the image of the one line. Furthermore, the control portion 11 controls the speed of this movement. The detailed contents of the processings of the control portion 11 will be explained later.

The storage portion 12 is a storage device such as a RAM (random access memory) and holds therein the program executed by the control portion 11. The program may be provided in a manner of being stored in a CD-ROM (compact disc read only memory), a DVD-ROM (digital versatile disc-read only memory) or a portable-type memory device and stored in the storage portion 12. Further, the storage portion 12 operates also as the work memory of the control portion 11.

The operation portion 13 is configured by a ten key or a cross key for instructing the moving direction to the transversal and vertical directions, for example. The operation portion 13 outputs the contents of the operation performed by a user to the control portion 11. The display portion 14 is configured by a display device such as a liquid crystal display and displays an image such as a character sequence at a designated position in accordance with an instruction inputted from the control portion 11.

The communication portion 15 is a transceiver circuit for communicating with a network interface or a mobile phone network, for example, and transmits and receives information via a communication means such as a network or the mobile phone network. The communication portion 15 transmits information via the communication means in accordance with an instruction inputted from the control portion 11 and outputs information received via the communication means to the control portion 11.

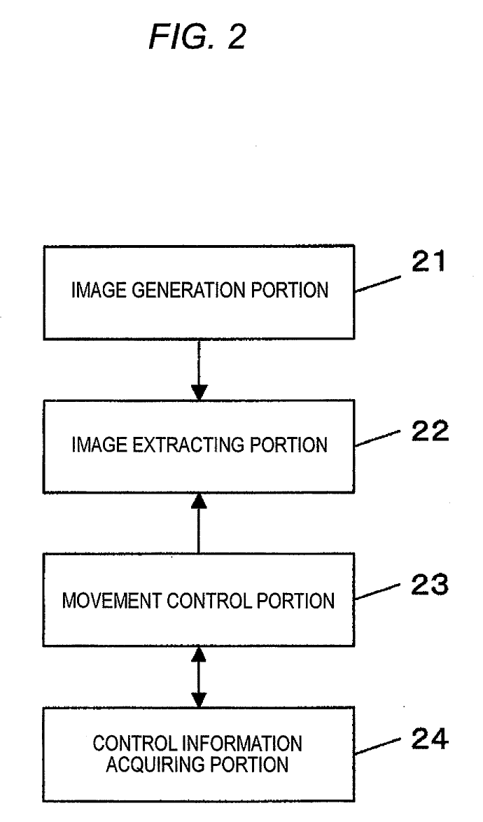

Next, the contents of the processings performed by the control portion 11 will be explained. The control portion 11 according to the embodiment is configured functionally to include an image generation portion 21, an image extracting portion 22, a movement control portion 23 and a control information acquiring portion 24 as shown in FIG. 2 as an example.

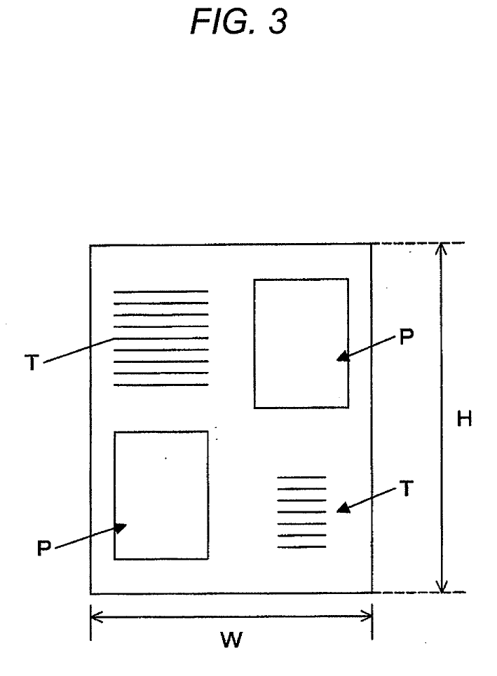

The image generation portion 21 acquires data of a document subjected to the processing. The document data may include picture portions (P) such as a drawing or a picture as well as character sequence portions (T) as shown in FIG. 3 as an example. The image generation portion 21 discriminates the character sequence portion (T) by the well-known layout analysis processing, for example, and extracts an image (original image) of the character sequence portion.

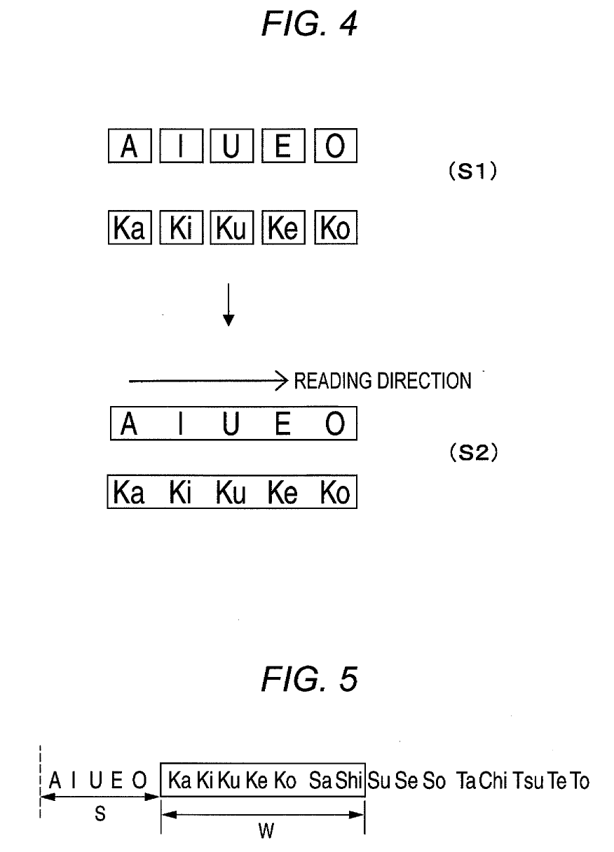

The image generation portion 21 discriminates areas in each of which significant pixels continue, for example, from the original image thus extracted, then groups the areas in each of which a distance between the adjacent areas is equal to or less than a threshold value, and discriminates a block of pixels constituting each character. Then, a character circumscribed rectangle which circumscribes each character is defined ((S1) of FIG. 4).

Next, the image generation portion 21 determines that characters are read in a direction of a shorter distance between an average distance between the adjacent character circumscribed rectangles in the vertical direction and an average distance between the adjacent character circumscribed rectangles in the transversal direction, and acquires a line circumscribed rectangle which further circumscribes a plurality of the character circumscribed rectangles in the character reading direction ((S2) of FIG. 4).

Then, the image generation portion 21 couples the respective line circumscribed rectangles as a single line to thereby generate an image of a virtual line. This line image may be scaled up or scaled down by a predetermined or designated scale-up/scale-down ratio. When there are a plurality of character sequence portions each to be an original image within the document data, line images respectively generated from the original images may be coupled in a predetermined order (for example, a character line portion on the upper side is selected with a higher priority, and a character line portion on the left side is selected with a higher priority when there are a plurality of character line portions on the same height) to thereby generate a single line image (a character sequence image arranged on a line virtually).

The image extracting portion 22 extracts a part of the character sequence image arranged on the line virtually as a display area. For example, the image extracting portion 22 extracts, from the character sequence image arranged on the line, an area of w pixels corresponding to the displayable width of the display portion 14 from the position moved by s pixels from the left end of the character sequence image (that is, a portion from the position of s-th pixel from the head portion to the position of (s+w)-th pixel) as the display area. Then, the image extracting portion 22 displays the image thus extracted on the display portion 14.

This display area is moved by the movement control portion 23 with the lapse of time. Thus, the character sequence image is displayed in a manner of the sticker display (scroll display). The movement control portion 23 instructs the image extracting portion 22 so as to move the display area in the reading direction of the character sequence at a designated moving speed (for example, p pixels/sec.) as described later.

Thus, the image extracting portion 22 extracts the images within the display area at respective time points while moving the display area at the designated moving speed and outputs the extracted image to the display portion 14 to thereby update the image to be displayed on the display portion 14.

The movement control portion 23 controls the moving speed based on control information acquired by the control information acquiring portion 24. The control information includes (1) information representing the operation of a user at the operation portion 13 and (2) information relating to operations having been performed by a user (or may be other person).

When the information representing the operation of a user at the operation portion 13 is acquired, the movement control portion 23 determines the moving speed based on the information representing the operation and instructs the image extracting portion 22 so as to move the display area in the reading direction of the character sequence at the determined moving speed. For example, the moving speed of the display area may be determined so as to be p pixels/sec. while the operation is not performed, whilst may be determined to be p+Δp pixels/sec. while a user pushes down a right-direction arrow key among the arrow keys. Alternatively, the moving speed of the display area may be determined so as to be p−Δp pixels/sec. while a user pushes down a left-direction arrow key among the arrow keys, whilst may be determined so as to be −p pixels/sec. when the left-direction arrow key is pushed twice continuously (that is, the display are is moved in the direction in opposite to the reading direction of the character sequence at the speed of p pixels/sec.).

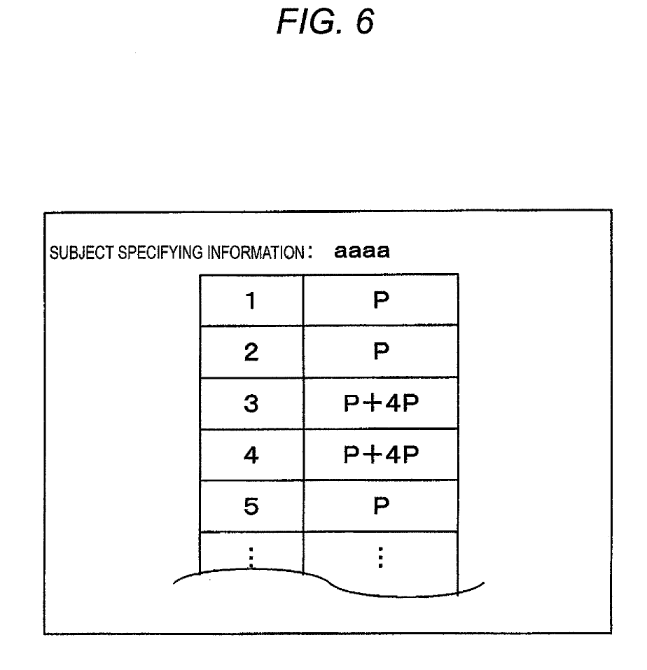

Further, the movement control portion 23 stores the information relating to the operations having been performed. As an example, as shown in FIG. 6, the movement control portion 23 stores the information of the moving speed determined according to the key push-down operation etc. of a user in relation with the information for specifying the character sequence to be displayed (subject specifying information). The information of the moving speed is configured in a manner that the information representing the moving speed at the time of displaying the display area specified by the information for specifying the display area is related to this information for specifying the display area (for example, a value of the pixel at the left end of the display area). The movement control portion 23 may store these information in the storage portion 12 or transmit these information to the external server 2 and store therein.

Further, the movement control portion 23 may determine the moving speed in the following manner. That is, the movement control portion 23 outputs the subject specifying information for specifying the character sequence to be displayed to the control information acquiring portion 24 to thereby request the information relating to the past operations relating to this subject specifying information (the past designated contents of the moving speed). When the control information acquiring portion 24 acquires, in response to the request, the information (the past designated contents of the moving speed) relating to the operation of a user (or may be other person) performed in the past from the storage portion 12 or the external server 2, the movement control portion 23 controls the moving speed of the display area based on the information representing the past designated contents of the moving speed. Further, when the past designated contents of the moving speed is not acquired, the display area may be moved at the predetermined moving speed and the moving speed may be changed based on the operation of a user as described above.

As described above, the information representing the past designated contents of the moving speed is configured in a manner, as shown in FIG. 6, that the information representing the moving speed at the time of displaying the display area specified by the information for specifying the display area is related to this information for specifying the display area (for example, a value of the pixel at the left end of the display area). Thus, the movement control portion 23 acquires the information for specifying the display area currently extracted by the image extracting portion 22 (current position information), then takes out the information of the moving speed related to the current position information and outputs the information of the moving speed thus taken out to the image extracting portion 22.

When the past designated contents of the moving speed is acquired and the operation of a user is accepted, the movement control portion 23 may treat the current operation of the user with a higher priority to thereby control the moving speed based on the current operation of the user irrespective of the past designated contents of the moving speed. Alternatively, when the past designated contents of the moving speed is acquired and the operation of a user is accepted, the movement control portion 23 may perform the statistical arithmetic operation (for example, arithmetic average, weighted average, center value extraction, maximum value extraction, minimum value extraction etc.) between a moving speed p1 determined based on the current operation of the user and a moving speed p2 determined based on the past designated contents of the moving speed, and may control the moving speed based on the result of the statistical operation.

In this manner, the portion 35 designates the moving speed of the display area based on at least one of the contents of the operation accepted from a user and the past designated contents of the moving speed.

The control information acquiring portion 24 accepts the inputted subject specifying information for specifying the character sequence to be displayed, and checks whether or not the information representing the past designated contents of the moving speed related to the inputted subject specifying information exists in a predetermined storage portion such as the storage portion 12 of the server 2. When the information representing the past designated contents of the moving speed related to the inputted subject specifying information exists in the predetermined storage portion, the control information acquiring portion 24 acquires the information and outputs to the movement control portion 23. Further, the control information acquiring portion 24 outputs the contents of the operation performed by the user at the operation portion 13 to the movement control portion 23.

Thus, the information display apparatus 1 according to the embodiment operates in the following manner. The information display apparatus 1 accepts a document including information of character sequence and extracts the information of character sequence from the document. Then, the information display apparatus 1 further takes out an image at every line from the extracted character sequence information, and couples the end portion of the image of the n-th line with the head portion of the image of the (n+1)-th line to thereby generate an image of one line.

The information display apparatus 1 at first cuts out a display area including a portion of a predetermined width w from the left end of the image of this line and outputs the display area thus cut out to the display portion 14.

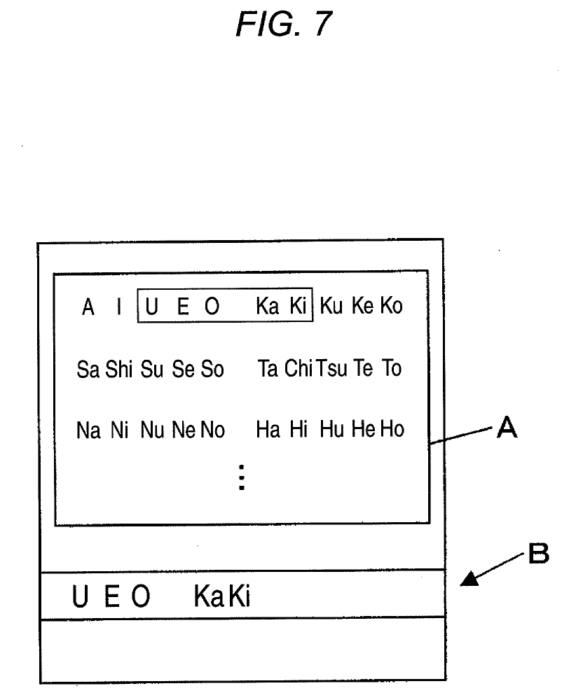

The display contents in this case is that a part (B) of the image of one line is displayed as shown in FIG. 7 as an example. At the time of displaying this image, the information display apparatus 1 may generate information (A) representing that which part of the original character sequence image (original image) corresponds to the part. For example, the information display apparatus 1 generates a scaled-down image which is acquired by scaling down the original image with a ratio b.

Further, the information display apparatus 1 acquires the number of the line where the left end of the display area locates. In order to enable the acquiring of this line number, the information display apparatus 1 stores in advance, at the time of generating the line image, pixel numbers to the head portions of the respective lines (line head positions) from the left end of the line image in association with the line numbers, respectively. Then, a line belonging to the position at the left end of the display area (the pixel number x from the left end of the line image) at the time of the processing may be acquired with reference to the stored information.

The information display apparatus 1 draws a rectangle, on the scaled-down image, which surrounds an area from a position of ((x−X(L))/b)-th pixel in the character reading direction of the line acquired in the aforesaid manner (L-th line) to a position of ((x−X(L))/b+w/b)-th pixel. In this case, X(L) represents the pixel number of the head portion of the line related to the line number L thus acquired. When the right end of this rectangle exceeds the head position X(L+1)/b of the next line, that is, when a relation of (x−X(L))+w>X(L+1) is satisfied, the information display apparatus draws a rectangle which surrounds an area from the position of ((x−X(L))/b)-th pixel in the character reading direction of the line acquired in the aforesaid manner (L-th line) to the end of the line and further draws a rectangle which surrounds an area from the head position of the next line ((L+1)-th line) to a position of ((x−X(L))/b+w/b−X(L+1)/b)-th pixel.

Although the aforesaid explanation shows the example where the past moving speed information is used as it is in the case of designating the moving speed based on the past designated contents of the moving speed, the invention is not limited thereto. That is, the information display apparatus 1 according to the embodiment acquires the information (the past designated contents of the moving speed) relating to the operations of a user (or may be other person) performed in the past, and acquires the information (current position information) for specifying the current display area to thereby take out the information of the moving speed related to the current position information. Then, the moving speed information thus taken out is converted by a predetermined method.

This conversion method may be arranged to convert the information by using a table which relates numerical values before conversion with numerical values after conversion or by using a mathematical expression. The conversion may be performed in a manner, for example, that the moving speed is converted into a speed lower than the moving speed designated in the past when the past designated moving speed is lower than a predetermined reference speed, whilst the moving speed is converted into a speed higher than the past designated moving speed when the past designated moving speed is higher than the predetermined reference speed. In this case, the reference speed may be the moving speed at the time where the operation is not performed.

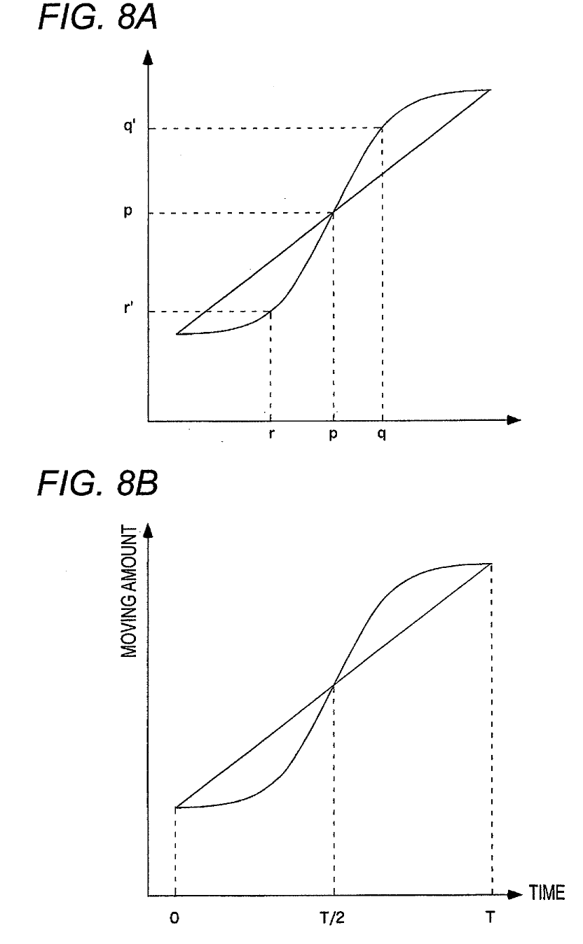

FIG. 8(a) shows an example of the contents of the table, in which when the past actual moving speed is a speed r lower than the reference speed p, the speed is converted into a speed r′ lower than the past actual moving speed to thereby emphasize the user's intention of “setting to be lower than a speed in a state of no operation”. In contrast, when the past actual moving speed is a speed q higher than the reference speed p, the speed is converted into a speed q′ higher than the past actual moving speed to thereby emphasize the user's intention of “setting to be higher than a speed in a state of no operation”.

An example of the conversion is not limited to the aforesaid case. For example, a section (time period) where the display area moved at a constant speed may be extracted from the information shown in FIG. 6 as an example. Then, as shown in FIG. 8(b), the moving speed within this section (time period) may be changed without changing the moving distance in a manner that the speed is set to be low initially, then set to be higher than the past designated speed on the way and set to be low again before the stoppage. FIG. 8(b) represents a case where the moving amount is shown with respect to the time lapse.

That is, as shown in FIG. 6 as an example, when the information representing the past operations is configured in a manner that the information representing the moving speed, at the time where the display area specified by the information specifying the display area is displayed, is related to the information specifying the display information (for example, a pixel value at the left end of the display area), the information display apparatus 1 rearranges the information specifying the display area in the order of the magnitude of the pixel values from the small value to the large value to thereby specify a section where the same moving speed appears. Then, the information display apparatus calculates a moving distance POS2−POS1 with reference to the information POS1 specifying the first display area of this section and the information POS2 specifying the last display area of this section. Further, the information display apparatus acquires the moving speed (constant speed q) during the moving distance and calculates a moving time period T=q/(POS2−POS1). Then, the moving speed q at a time point t during the moving time period T (from the time 0 to the time T) is determined by a function q′=f(q, T, t) representing the moving speed at the time point t, as shown in FIG. 8(b). In this example, the following expressions are satisfied when the start time of each section is 0:

f(q, T, t)<q(t<T/2)

f(q, T, T/2)=q

f(q, T, t)>q(t>T/2)

∫₀^{T}(q, T, t)dt=qT

In the case where the past designated contents of the moving speed is stored in the server 2, for example, a plurality of the past designated contents of the moving speed may be provided in association with the common subject specifying information. In this case, the moving speeds acquired by the respective designated contents may be subjected to the statistical arithmetic operation to thereby acquire a moving speed to be instructed. In the case where it is permitted to use the past designated contents of the moving speed of other person, in the case of recording the contents of the operation performed by a user in the server 2 etc., the information relating to the user may be stored in association with the record. The information relating to the user may be information of an age, a specialized field (job), native language etc., for example. The information display apparatus 1 according to the embodiment may be arranged to receive the input of these information from a user and store in the storage portion 12 in advance and the control portion 11 contains these information in the record.

In the case of acquiring the past designated contents of the moving speed, when there are a plurality of the information of the designated contents, the control portion 11 may refer to the information relating to the user stored in the storage portion 12 and acquire the designated contents including the information most relevant to the refereed information (in the case where there many coincide items or the information is represented by numerical values such as the ages, the determination may be performed by using the information having the least difference of the numerical value or the weight sum between the number of the coincide items and the numerical difference in the item represented by the numerical value). According to this method, the past designated contents of other person close in the age or the specialized field etc. can be referred. Further, day and time may be further recorded so as to use the information of the recent day.

This record may include the information such as the type of the information display apparatus 1 or the kinds (the kind such as a touch panel, arrow keys, ten keys) of the operation portion 13. That is, the information display apparatus 1 according to the embodiment can be realized in a mobile phone and also in a personal computer. Thus, the past designated contents of the moving speed of the same type used by a user may be acquired with a higher priority. Also, in the case of acquiring the past designated contents of the moving speed, when there are a plurality of the information of the designated contents, the control portion 11 may refer to the information relating to the user or the types etc. stored in the storage portion 12 and acquire the designated contents including the information most relevant to the refereed information (in the case where there many coincide items or the information is represented by numerical values such as the ages, the determination may be performed by using the information having the least difference of the numerical value or the weight sum between the number of the coincide items and the numerical difference in the item represented by the numerical value).

The embodiment is not limited to the case of performing the ticker display of only one line. For example, the processing may be performed in the following manner. That is, the control portion 11 of the information display apparatus 1 according to the embodiment recognizes the end positions on the side in opposite to the character reading direction of the line circumscribed rectangles found in the processing S2 of FIG. 4 as the start positions (L1, L2, - - - ) of the lines, and records the height (hn) of the line circumscribed rectangle, the width (wn) of the line circumscribed rectangle and a distance (ln) to the adjacent line circumscribed rectangle concerning each of the line circumscribed rectangles are recorded as the height of the line, the width of the line and the length between the lines, respectively. Further, the maximum width wmax is detected among the widths of the respective line circumscribed rectangles to thereby acquire a difference Wrest_n from the width of each of the line circumscribed rectangles as Wrest_n=wmax−wn. The Wrest_n represents the width of a space portion of the n-th line. Further, the value Lmin of the start position located at the most end position on the side in opposite to the character reading direction (that is, most left side in the case of reading from the left to the right) among the start positions of the lines of the respective line circumscribed rectangles is acquired, and the space |Ln−Lmin| on the line head portion side and the space Wrest_n−|Ln+Lmin| on the line end portion side may be further calculated as the information of the space portions. In this case, |x| represents the absolute value of x. Hereinafter, the width of the original image (the length in the character sequence reading direction) is se to be W and the height (the length in the arrangement direction of the line of the character sequence) is set to be H.

The control portion 11 secures the storage area of an image of a width (2·W) and a height (2·H) at the minimum. Further, the control portion 11 at first sets a variable n representing a line to be noticed as n=1. Hereinafter, in order to simplify the explanation, the explanation will be made based on that the reading direction of the character sequence is from the left to the right (X-axis direction). In the case of arranging the character sequence from the upper direction to the lower direction, for example, the axis may be changed. Also, in the case of reading the character sequence from the right to the left, the direction of the axis may be reversed.

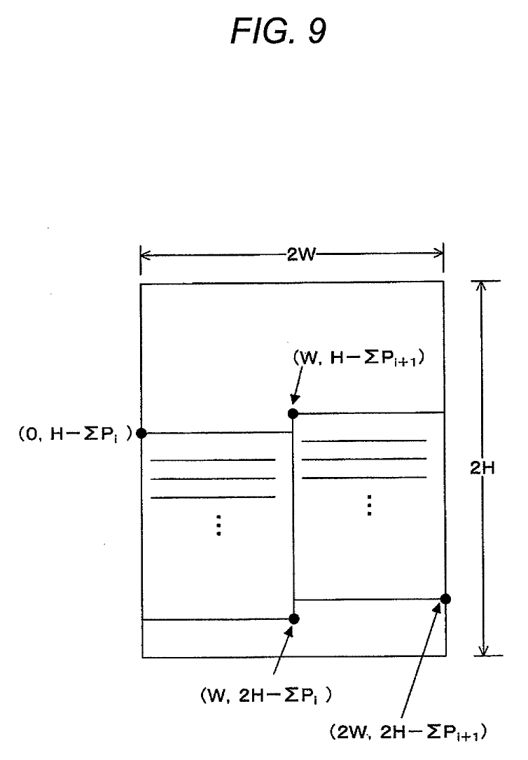

The control portion 11 disposes the original image in a range of (O, H−ΣPi−1)−(W, 2·H−ΣPi−1) of the secured area, for example, and also disposes the same original image in a range of (W, H−ΣPi)−(2·W, 2·H−ΣPi) (FIG. 9). Pi represents a width between the i-th line and the next (i+1)-th line, and Pi may be represented by Pi=hi+li or Pi=(hi+hi+1)/2+li, for example. In the former case, the preceding line coincides with the upper portion of the next line. In the latter case, the preceding line coincides with the center portion of the next line. Further, ΣPi represents a value acquired by adding Pi from i=1 to i=n (n is a line to be notified).

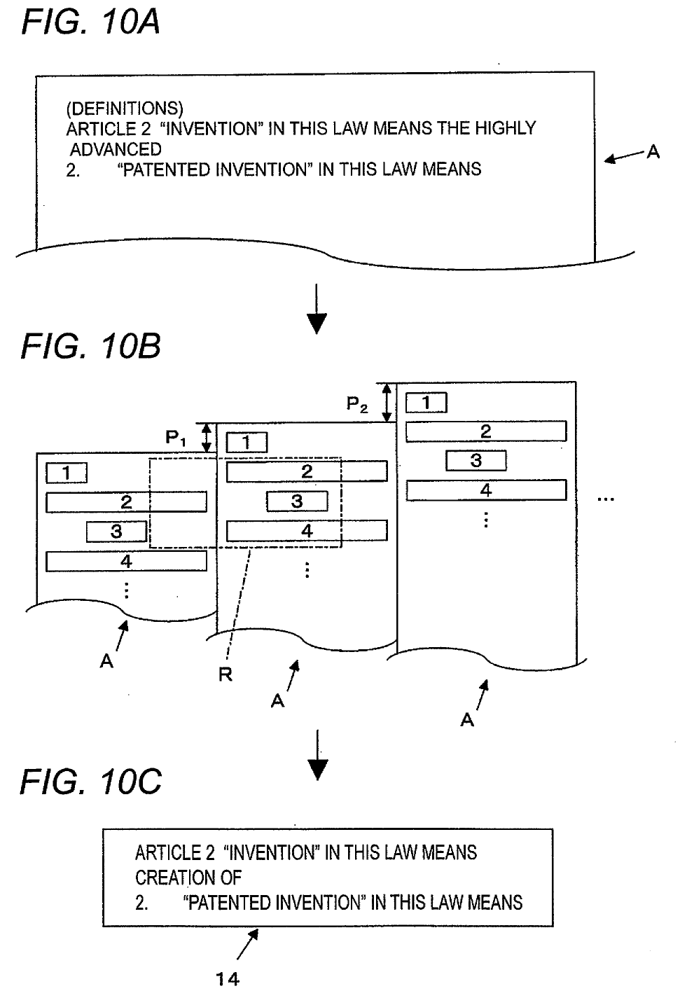

In this manner, the control portion 11 arranges the original image continuously in a repetition manner in the character reading direction and arranges an image to be disposed in adjacent thereto in a manner of being shifted by Pn corresponding to a line in the line arrangement direction. That is, the image generation portion 21 arranges a plurality of the original images A so as to be shifted by one line to each other in the character reading direction, as shown in FIG. 10 as an example, whereby an image is formed in a manner that the end portion of n-th line of the character sequence information is coupled to the start portion of (n+1)-th line thereof as a line. In the example shown in FIG. 10, an image is generated wherein the character sequence of the corresponding respective lines of the images are aligned at the same height (called a line-coupled image) in a manner that the first line of the first original image is arranged at the same height as the second line of the next (second) original image, and the second line of the second original image is arranged at the same height as the third line of the third original image etc.

The control portion 11 extracts a part of the line-coupled image, that is, a range containing parts of the coupled lines as the display area and outputs the extracted image to the display portion 14 and displays thereon. As an example, when the displayable range of the display portion 14 corresponds to the shape and the size shown by a rectangle (display area R) with a width Rw and a height Rh, the control portion 11 extracts an image of the display area R and outputs (FIG. 10(c)).

The control portion 11 extracts the image portion within the display area R and outputs the extracted image to the display portion 14 while moving the display area R at the designated speed on the line-coupled image.

Further, when the coordinate at the end side in opposite to the moving direction of the display area R reaches the boundary of the original images disposed repeatedly, that is, when the coordinate of the X-axis (a shaft extending in the left and right directions is called an X-axis) on the left end side of the display area R reaches the width W of the original image, the control portion 11 moves the original image disposed in the range of (W, H−ΣPi)−(2·W, 2·H−ΣPi) to the range of (O, H−ΣPi)−(W, 2·H−ΣPi). Further, the original image is newly disposed in a rage of (W, H−ΣPi+1)−(2·W, 2·H−ΣPi+1). Furthermore, W is subtracted from the X-coordinate of the display area R. In this case, the moving speed of the display area R is designated by the aforesaid method.

In the case of reversing the moving direction, when the coordinate at the end side in opposite to the moving direction of the display area R reaches the boundary of the original images disposed repeatedly, that is, when the coordinate of the X− on the right end side of the display area R reaches the width W of the original image, the control portion 11 moves the original image disposed in the range of (O, H−ΣPi)−(W, 2·H−ΣPi) to the range of (W, H−ΣPi)−(2·W, 2·H−ΣPi). Further, the original image is newly disposed in a rage of (O, H−ΣPi−1)−(W, 2·H−ΣPi−1). Further, W is added the the X-coordinate o f the display area R.

Further, in this case, the control portion 11 may move the position of the extracted area R to the previous line or the next line in response to an instruction from a user etc. That is, when an instruction of moving to the previous line is received, the control portion 11 moves the position of the display area R by the width W of the original image in the direction in opposite to the character sequence reading direction from the position of the display area at the time of receiving the instruction. In contrast, when an instruction of moving to the next line is received, the control portion 11 moves the position of the display area R by the width W of the original image in the direction in the character sequence reading direction from the position of the display area at the time of receiving the instruction.

When there are a plurality of character sequence information (character sequence portions found by the layout analysis processing) arranged in plural lines, as described above, the plurality of character sequence information are ordered in the predetermined order and the respective images thereof are subjected to the processing. In this case, the control portion 11 may couple the end portion of the last line of the i-th character sequence information (the image of the character sequence portion) with the head portion of the first line of the (i+1)-th character sequence information (the image of the character sequence portion) as one line to generate a line-coupled image.

Further, the control portion 11 may differentiate color between characters (called characters of other lines) of lines other than a line in a range (notified position) where characters being read by a user such as the center portion of the display area R are to be displayed and characters (called notified characters) which are contained in the line at the notified position and located in a predetermined range at least from the notified position. As an example, the characters of other lines may be shown by light gray and the notified characters may be shown by dark gray or black.

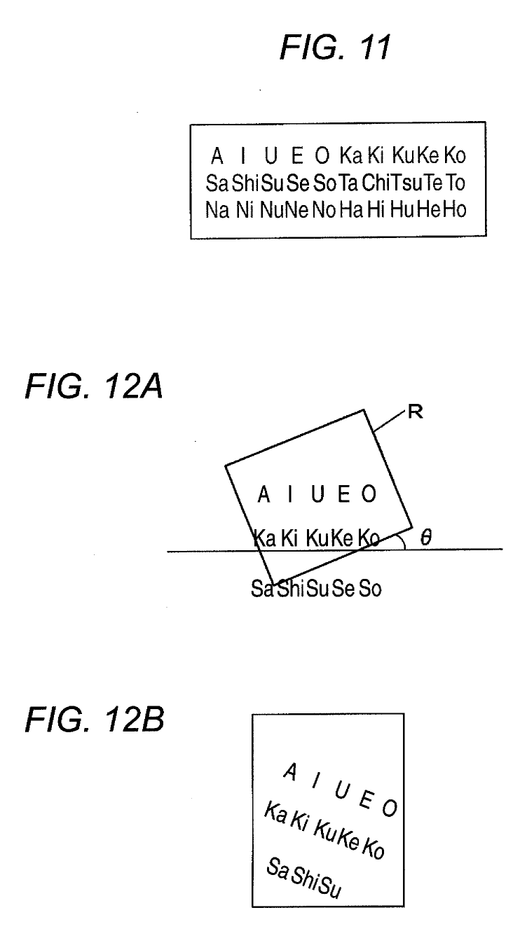

Furthermore, the control portion 11 may differentiate color between the notified characters and characters which are contained in the line at the notified position but located outside of the predetermined range from the notified position. For example, such the characters may be displayed so as to be more light in accordance with the distance from the notified position (FIG. 11).

Although the explanation is made as to the case where the display area R is formed in a rectangle in a manner that a pair of the sides thereof are set to be in parallel to the respective lines contained in the line-coupled image, the embodiment is not limited thereto. That is, in order to clearly indicate to a user that a line to be read will shift to the next line while reading, the extracted area R may be slanted by an angle Θ as shown in FIG. 12(a) so that the character sequence of the line to be notified are arranged toward the obliquely lower direction (FIG. 12(b)).

Further, the control portion 11 of the information display apparatus 1 according to the embodiment may be arranged to be changeable between the a mode for displaying the line-coupled image in a scrolling mode and a mode for displaying the line-coupled image in a non-scrolling mode. In this case, in the scrolling mode, the display shown in FIG. 7 as an example may be performed in a manner that characters of lines other than the line at the notified position are displayed by relatively light gray. In contrast, in the non-scrolling mode, the entire characters may be displayed as character image of the uniform density. Further, in the non-scrolling mode, the line including the notified position may be underlined or may be surrounded by a rectangle.

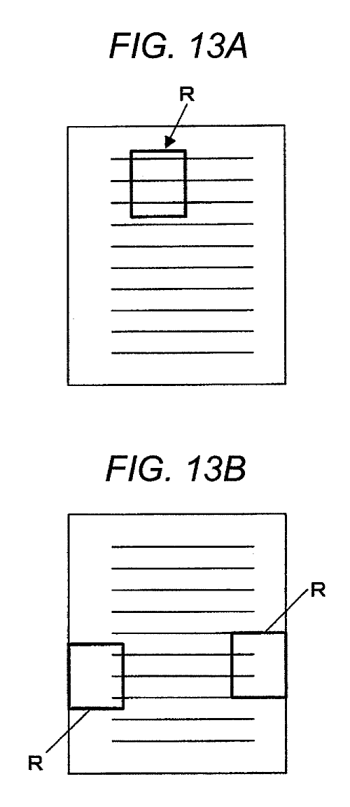

Furthermore, as shown in FIG. 13, the control portion 11 may display an indication (entire indication) representing the display area R on the original image. In this case, the entirety of the original image is displayed on the entirety of the display area of the display portion 14 and the rectangle representing the area displayed in the non-scrolling mode is displayed (FIG. 13(a)). When the current display area R locates over the adjacent lines, the rectangle is displayed in a separated manner of the left and right pieces (FIG. 13(b)).

The control portion 11 may be arranged so as to be changeable among the entire indication, the scroll mode and the non-scroll mode.

Further, when it is determined that the notified position (for example, the center coordinate) of the display area R locates between the left end of the space |Ln−Lmin| on the line head portion side and the left end of the original image by using the |Ln−Lmin| on the line head portion side of the notified n-th line and Wrest_n−|Ln+Lmin| on the line end portion side, the control portion 11 may set the scrolling speed (the moving speed of the display area R) to be higher than the designated speed. In contrast, when the notified position (for example, the center coordinate) of the display area R locates between the left end of the space Wrest_n−|Ln+Lmin| on the line end portion side (that is, the tip end of the space) and the right end of the original image, the scrolling speed (the moving speed of the display area R) may be set to be higher than the designated speed.

The aforesaid explanation is made as to the case where the character sequence image contained in the original image is a bit map image. However, when there is provide with information of the codes of the character sequences contained in the original image (that is, information for discriminating the kinds of the characters such as Chinese characters, Japanese syllabary, alphabets), the control portion 11 may differentiate the scrolling speed (the moving speed of the display area R) from the designated speed depending on the kind of the characters at the notified position (for example, the center coordinate) of the display area R. For example, the scrolling speed may be set to be lower than the designated speed when the character is a Chinese character, and the scrolling speed may be set to be higher than the designated speed when the character is a Japanese syllabary or an alphabet.

The changing amount of the scrolling speed from the designated speed may be differentiated depending on the degree of difficulty of reading of Chinese characters such as the number of strokes in a Chinese character or the JIS (Japan Industrial Standard) level of a Chinese character.

Further, the designated speed of the scrolling speed may be changed depending on the modified state of a character at the notified position (for example, the center coordinate) of the extracted area R. For example, the scrolling speed may be set to be lower than the designated speed when the size of a character is large. Further, the scrolling speed may be set to be lower than the designated speed when a character is bolded.

Further, the designated moving speed of the display area R may be changed depending on whether or not the character sequence around the notified position (for example, the center coordinate) of the display area R is a character sequence contained in a predetermined dictionary. For example, words used in general are stored in a dictionary in advance, and the scrolling speed may be set to be lower than the designated speed when the character sequence does not coincide with the words stored in the dictionary.

Further, the designated moving speed may be changed depending on the distances between the characters of the character sequence. For example, the lower the distance between the characters becomes, the lower the scrolling speed may be set to than the designated speed.

Further, although the explanation is made as to the case where two original images are disposed in the reading direction, the control portion 11 may dispose many original images in the reading direction. In this case, the j-th original image from the left (supposing to be the original image having the notified line at i-th line) is disposed at the position of ((j−1)·W, H−ΣPi)−(j·W, 2·H−ΣPi). In this case, the original image not overlapping with the display area R is deleted, and the positions of the respective original images and the position of the display area R are shifted to the direction of the deleted original image.

The embodiment may be arranged in a manner that the processing of the image generation portion 21 may not performed by the information display apparatus 1 but by the server 2, and the character sequence image virtually disposed on a line as the result of the processing may be transmitted to the information display apparatus 1 so that the succeeding processings are performed by the information display apparatus 1.

Further, the processing of the image extracting portion 22 may also be performed by the server 2. In this case, the information display apparatus 1 transmits the moving speed determined by the movement control portion 23 to the server 2. Then, the server 2 performs the processing as the image extracting portion 22 to set the display area and transmits the image within the display area thus set to the information display apparatus 1. Then, the information display apparatus 1 receives the image from the server 2 and displays.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information display apparatus comprising:
an extracting unit that extracts a part of an image of a character sequence virtually arranged in a line, as a display area;
a display unit that displays the part of the image of the character sequence within the extracted display area;
a moving unit that moves the display area on the image of the character sequence; and
a designating unit that designates a moving speed of the display area based on at least one of contents of an operation performed by a user and contents of the moving speed designated in past.

2. The information display apparatus as claimed in claim 1,
wherein
the designating unit records, in a case where an operation for designating the moving speed of the display area is performed by a user, information of the moving speed designated by the operation as the contents of the moving speed designated in past, in association with information specifying the display area at a time where the operation is performed.

3. The information display apparatus as claimed in claim 2,
wherein
the designating unit acquires the contents of the moving speed designated in past, and designates the moving speed based on the information of the moving speed in association with the information specifying the display area at respective times where the moving speed is designated.

4. The information display apparatus as claimed in claim 1,
wherein
the designating unit, in a case where designating the moving speed based on the contents of the moving speed designated in past, converts the moving speed designated based on the contents of the moving speed designated in past in accordance with a predetermined method, and designates a moving speed acquired by the conversion.

5. The information display apparatus as claimed in claim 4,
wherein
the designating unit converts the moving speed designated based on the contents of the moving speed designated in past in a manner that the designated moving speed is converted in a speed lower than the designated moving speed in a case where the designated moving speed is lower than a reference speed, and the designated moving speed is converted in a speed higher than the designated moving speed in a case where the designated moving speed is higher than the reference speed.

6. An information displaying method comprising:
extracting a part of an image of a character sequence virtually arranged in a line, as a display area;
displaying the part of the image of the character sequence within the extracted display area;
moving the display area on the image of the character sequence; and
designating a moving speed of the display area based on at least one of contents of an operation performed by a user and contents of the moving speed designated in past.

7. A computer readable medium storing a program causing a computer to execute a process for displaying character sequence information, the process comprising:
extracting a part of an image of a character sequence virtually arranged in a line, as a display area;
displaying the part of the image of the character sequence within the extracted display area;
moving the display area on the image of the character sequence; and
designating a moving speed of the display area based on at least one of contents of an operation performed by a user and contents of the moving speed designated in past.
